(19) United States
(12) Patent Application Publication
(10) Pub. No.: US 2012/0326547 A1
(43) Pub. Date: Dec. 27, 2012

(54) MOTOR HAVING ROTOR AND METHOD FOR MANUFACTURING THE ROTOR

(75) Inventors: Takumi Suzuki, Toyohashi-shi (JP); Yuusuke Tateishi, Kosai-shi (JP)

(73) Assignee: ASMO CO., LTD., Kosai-shi (JP)

(21) Appl. No.: 13/493,789

(22) Filed: Jun. 11, 2012

(30) Foreign Application Priority Data
Jun. 21, 2011 (JP) 2011-137757
Aug. 30, 2011 (JP) 2011-187909

(51) Int. Cl. H02K 1/28; H02K 15/02

(52) U.S. Cl. 310/156.15; 29/598

(57) ABSTRACT

A rotor core has installation portions in which first magnets, which are permanent magnets, are arranged. The installation portions are larger than the first magnets. The first magnets are divided into a first group and a second group. The first magnets in the first group are fixed to the installation portions to be offset in the positive rotational direction of the rotor toward the pseudo magnetic poles or the different magnetic poles. The permanent magnets in the second group are fixed to the installation portions to be offset in the inverse rotational direction of the rotor toward the pseudo magnetic poles or the different magnetic poles.

### BACKGROUND

The present invention relates to a motor having a rotor. The present invention also relates to a method for manufacturing the rotor.

For example, Japanese Laid-Open Patent Publication No. 9-327139 discloses a brushless motor having a consequent pole rotor. The brushless motor having a consequent pole rotor reduces the number of the permanent magnets in the rotor by half, thereby reducing the costs.

In a consequent pole rotor, magnet magnetic pole portions and pseudo magnetic pole portions appear alternately. Therefore, when the magnetic balance is poor, the cogging torque is increased. Thus, to improve the magnetic balance, permanent magnets needs to be accurately fixed to the surface of the rotor core in a consequent pole rotor.

When fixed to the rotor core, all the permanent magnets are offset either in the clockwise or counterclockwise direction, that is, offset either in the positive rotational direction or in the inverse rotational direction. For example, a jig is applied to a side of each pseudo magnetic pole portion facing in the positive rotational direction, and a permanent magnet is brought into contact with the jig. The permanent magnet is then fixed to the surface of the rotor core. In this manner, all the permanent magnets are accurately offset in the same direction, for example, in the direction of the positive rotation.

However, in such offset fixation described above, all the permanent magnets are offset in the same direction when fixed. In the case of a consequent pole rotor, all the permanent magnets are offset in the same direction from the center in the distance between the corresponding adjacent pair of the pseudo magnetic poles, thereby cancelling the cogging torque generated in the pseudo magnetic poles by the cogging torque generated in the magnetic poles of the permanent magnets. Therefore, the effect of cancelling the cogging torque generated in the pseudo magnetic poles by the cogging torque generated in the magnetic poles of the permanent magnets is mitigated, and the cogging torque of the rotor increases. Also, since the magnetic poles are offset in the same direction from the center of the distance between adjacent pseudo magnetic poles, the cogging torque of the magnetic poles of the permanent magnets are added up, resulting in a great value of the cogging torque. These drawbacks are not unique to consequent pole rotors. It is believed that the same drawbacks are present in full magnet type rotors, in which permanent magnets arranged such that different polarities are alternately exposed in the circumferential direction.

Accordingly, it is an objective of the present invention to provide a motor that reduces the cogging torque of a rotor in the motor having a plurality of permanent magnets arranged in the peripheral direction of the rotor, and a method for manufacturing the motor.

### SUMMARY

In accordance with one aspect of the present invention, a motor is provided that includes a rotor. The rotor includes: a rotor core, which defines an axial direction and a rotor circumferential direction; a plurality of first magnetic poles, which are magnet magnetic poles, the first magnetic poles being formed in the rotor core by a plurality of first magnets, which are permanent magnets and arranged at predetermined intervals in the rotor circumferential direction, the first magnets being elongated in the axial direction; and a plurality of second magnetic poles provided in the rotor core to be alternately arranged with the first magnetic poles in the rotor circumferential direction, the second magnetic poles being different magnetic poles which are formed either by pseudo magnetic poles located between the first magnets or by second magnets, which are permanent magnets having a different polarity from that of the first magnets. The rotor core has installation portions, in which the first magnets are arranged, the installation portions being larger than the first magnets. The permanent magnets are divided into a first group and a second group. The first magnets in the first group are fixed to corresponding ones of the installation portions to be offset in the positive rotational direction of the rotor toward the second magnetic poles. The first magnets in the second group are fixed to corresponding ones of the installation portions to be offset in the inverse rotational direction of the rotor toward the second magnetic poles.

According to this configuration, the cogging torque of the rotor is reduced.

In accordance with one aspect, engaging portions for engaging with the first magnets in the rotor circumferential direction are provided in the installation portions of the above described motor. The first magnets in the first group are fixed to the installation portions to be offset in the positive rotational direction of the rotor and to be brought into contact with the engaging portions. The first magnets in the second group are fixed to the installation portions to be offset in the inverse rotational direction of the rotor and to be brought into contact with the engaging portions.

According to this configuration, the cogging torque of the rotor is reduced.

In accordance with one aspect, in the motor described above, when P represents an integer, the number of poles of the rotor is expressed by 4P, and the number of the first magnets is expressed by 2P. The first magnets, the number of which is expressed by 2P, are divided into the first group and the second group each having first magnets the number of which is expressed by P. The first magnets in the first group are fixed to the installation portions to be offset in the positive rotational direction of the rotor toward the second magnetic poles and to be engaged with the engaging portions. The first magnets in the second group are fixed to the installation portions to be offset in the inverse rotational direction of the rotor toward the second magnetic poles and to be brought in to contact with the engaging portions.

According to this configuration, the number (P) of the first magnets that are offset in the positive rotational direction toward the second magnetic poles is equal to the number (P) of the first magnets that are offset in the inverse rotational direction toward the second poles. This improves the magnetic balance and thus reduces the cogging torque of the rotor.

In accordance with one aspect, in the above described motor, when P represents an integer, the number of poles of the rotor is expressed by 4P+2, and the number of the first magnets is expressed by 2P+1. The first magnets, the number of which is expressed by 2P+1, are divided into the first group having first magnets, the number of which is expressed by P+1, and the second group having first magnets, the number of which is expressed by P. The first magnets in the first group are fixed to the installation portions to be offset in the positive rotational direction of the rotor toward the second magnetic poles and to be brought into contact with the engaging portions. The first magnets of second group are fixed to the installation portions to be offset in the inverse rotational direction of the rotor toward the second magnetic poles and to be brought into contact with the engaging portions.

According to this configuration, the difference between the number of the first magnets that are offset in the positive rotational direction toward the second magnetic poles and the number of the first magnets that are offset in the inverse rotational direction toward the second poles is one. This reduces displacement of the magnetic balance, and thus reduces the cogging torque of the rotor.

In accordance with one aspect, in the above described motor, the engaging portions are located on both ends in the rotor circumferential direction of each installation portion.

According to this embodiment, the first magnets can be divided into both directions and fixed.

In accordance with one aspect, in the above described motor, the installation portions each have a pair of ends in the rotor circumferential direction. Of the ends in the rotor circumferential direction of the installation portions, the engaging portions are located at the ends toward which the first magnets are offset.

This configuration reduces the number of engaging portions.

In accordance with one aspect, the above described motor has a stator, and the rotor is an inner rotor, which is located inward of the stator.

In accordance with one aspect, the above described motor has a stator, and the rotor is an outer rotor, which is located outward of the stator.

In accordance with one aspect, a method for manufacturing a rotor is provided. The method includes: preparing a rotor core, which defines an axial direction and a rotor circumferential direction; forming, in the rotor core, a plurality of installation portions in which a plurality of first magnets, which are permanent magnets, are arranged, the installation portions being larger than the first magnets, and each installation portion having ends in the rotor circumferential direction; dividing the first magnets into a first group and a second group, the first magnets being elongated in the axial direction; placing a jig at the end in the positive rotational direction of each installation portion; offsetting surfaces of the first magnets in the first group such that the surfaces contact the jigs, and fixing the first magnets in the first group to the installation portions; placing a jig at end in the negative rotational direction of each installation portion; offsetting the first magnets in the second group to contact the jigs, and fixing the first magnets in the second group to the installation portions, such that the first magnets are located on the rotor core to be arranged in the rotor circumferential direction at predetermined intervals, and that the first magnets form a plurality of first magnetic poles, which are magnet magnetic poles; and forming a plurality of second magnetic poles in the rotor core to be alternately arranged with the first magnetic poles in the rotor circumferential direction, the second magnetic poles being formed either by pseudo magnetic poles located between the first magnets or by second magnets, which are permanent magnets having a different polarity from that of the first magnets.

According to this configuration, using the jigs, the first magnets of the two groups are easily fixed after being divided into ones that are offset in the positive rotational direction toward the second magnetic poles and ones that are offset in the inverse rotational direction toward the second magnetic poles.

Other aspects and advantages of the invention will become apparent from the following description, taken in conjunction with the accompanying drawings, illustrating by way of example the principles of the invention.

### BRIEF DESCRIPTION OF THE DRAWINGS

The features of the present invention that are believed to be novel are set forth with particularity in the appended claims. The invention, together with objects and advantages thereof, may best be understood by reference to the following description of the presently preferred embodiments together with the accompanying drawings in which:

FIG. 1 is a diagram showing a brushless motor according to a first embodiment as viewed from the rear;

FIG. 2 is a front view showing the rotor of FIG. 1, as viewed from the rear;

FIG. 3 is a perspective view showing the rotor of FIG. 1;

FIG. 4 is a perspective view showing the rotor core of FIG. 1;

FIG. 5 is a front view showing the rotor core of FIG. 1, as viewed from the rear;

FIG. 6(a) is a partially developed view illustrating a manner in which the permanent magnets are divided and fixed with respect to pseudo magnetic poles of the rotor;

FIG. 6(b) is a partially developed view subsequent to FIG. 6(a), illustrating the manner in which permanent magnets are divided and fixed;

FIG. 7 is a diagram showing a brushless motor according to a second embodiment as viewed from the rear;

FIG. 8 is a front view, with parts cut away, showing the rotor of FIG. 7;

FIG. 9(a) is a partially developed view illustrating a manner in which the permanent magnets are divided and fixed with respect to pseudo magnetic poles of the rotor;

FIG. 9(b) is a partially developed view subsequent to FIG. 9(a), illustrating the manner in which permanent magnets are divided and fixed;

FIG. 10 is a diagram illustrating a method for dividing the permanent magnets to be offset and fixing the permanent magnets to the rotor core;

FIG. 11 is a diagram illustrating a method for dividing the permanent magnets to be offset and fixing the permanent magnets to the rotor core;

FIG. 12(a) is a partially developed view of an IPM rotor according to a modification, illustrating a manner in which permanent magnets are divided with respect to pseudo magnetic poles of the rotor;

FIG. 12(b) is a partially developed view subsequent to FIG. 12(a), illustrating the manner in which permanent magnets are divided and fixed;

FIG. 12(c) is a partially developed view of a rotor according to another modification, illustrating a manner in which permanent magnets are divided with respect to pseudo magnetic poles of the rotor;

FIG. 13 is a front view of a full magnet type rotor according to a modification;

FIG. 14(a) is a partially developed view illustrating a manner in which magnets of the full magnet type rotor of FIG. 13 are divided and fixed;

FIG. 14(b) is a partially developed view subsequent to FIG. 14(a), illustrating a manner in which the magnets of the full magnet type rotor are divided and fixed;

FIG. 15(a) is a partially developed view illustrating a manner in which magnets of a full magnet type rotor according to a modification are divided and fixed;

FIG. 15(b) is a partially developed view subsequent to FIG. 15(a), illustrating a manner in which the magnets of the full magnet type rotor are divided and fixed;

FIG. 16(a) is a partially developed view of an IPM rotor according to a modification, illustrating a manner in which the magnets of the rotor are divided and fixed;

FIG. 16(b) is a partially developed view illustrating a manner in which magnets of a rotor according to another modification are divided and fixed;

FIG. 16(c) is a partially developed view subsequent to FIG. 16(a), illustrating a manner in which the rotor magnets are divided and fixed; and

FIG. 16(d) is a partially developed view illustrating a manner in which magnets of a rotor according to another modification are divided and fixed.

### DESCRIPTION OF THE PREFERRED EMBODIMENTS

### First Embodiment

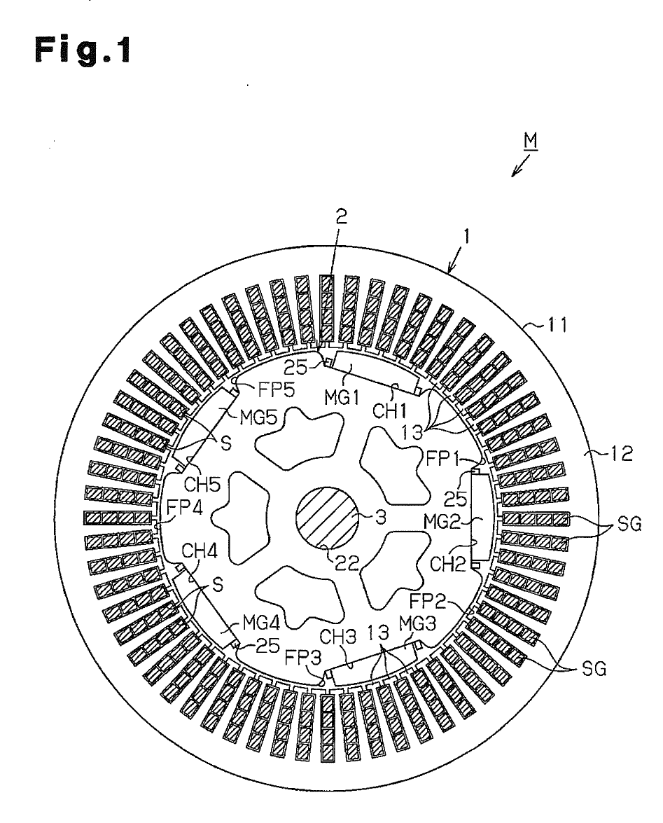

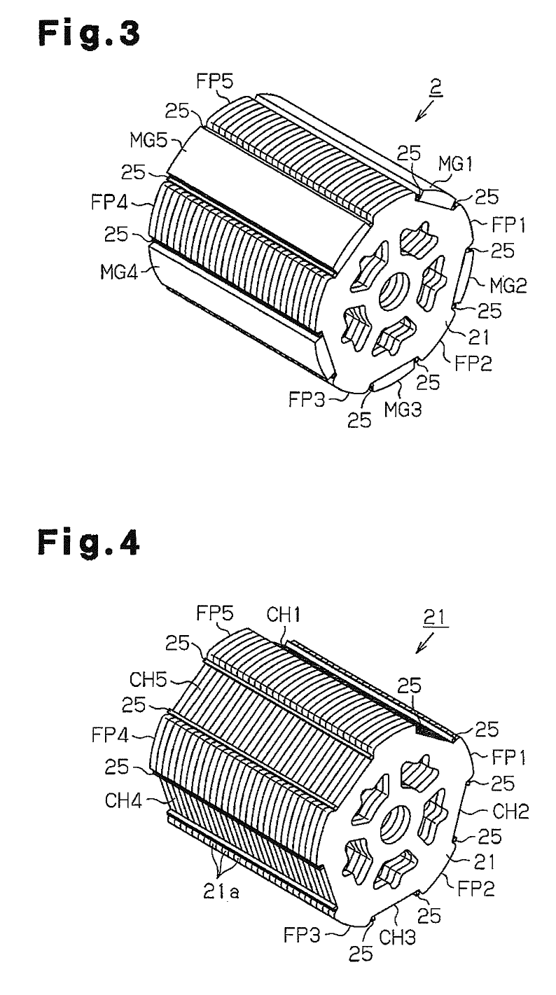

A brushless motor M according to a first embodiment of the present disclosure will now be described with reference to FIGS. 1 to 6.

As shown in FIG. 1, the brushless motor M of the present embodiment includes a rotor 2 located inside a cylindrical stator 1. The stator 1 is fixed to an inner surface of an unillustrated motor hosing case and includes a stator core 11. As shown in FIG. 1, the stator core 11 includes a cylindrical portion 12 and teeth 13. The teeth 13 extend radially inward from the cylindrical portion 12 and are arranged in the circumferential direction. In the present embodiment, sixty teeth are formed in the stator 1. Therefore, the number of slots S formed between the teeth 13 is also sixty.

A segment SG is inserted into each slot S from a rear side, which is one end in the axial direction of the stator core 11, toward a front side, which is the other end. The segments SG are connected with each other in accordance with predetermined rules, so that the stator 1 is formed to include a three-phase coil of a first system formed by a three-phase Y-connection and a three-phase coil of a second system.

Currents to the wound three phase coils of the first and second systems are controlled and a rotating magnetic field is generated in the stator 1. Accordingly, a rotary shaft 3 located inside the stator 1 is rotated in a positive direction or in an inverse direction. The positive rotation is in the clockwise direction as viewed in FIG. 1. The inverse rotation is in the counterclockwise direction as viewed in FIG. 1.

The rotor 2, which is arranged inside the stator 1, has a consequent pole structure as shown in FIG. 1. The rotary shaft 3 extends through and is fixed to the rotor 2. The rotary shaft 3 is rotationally supported by a pair of bearings provided on the housing case of the motor.

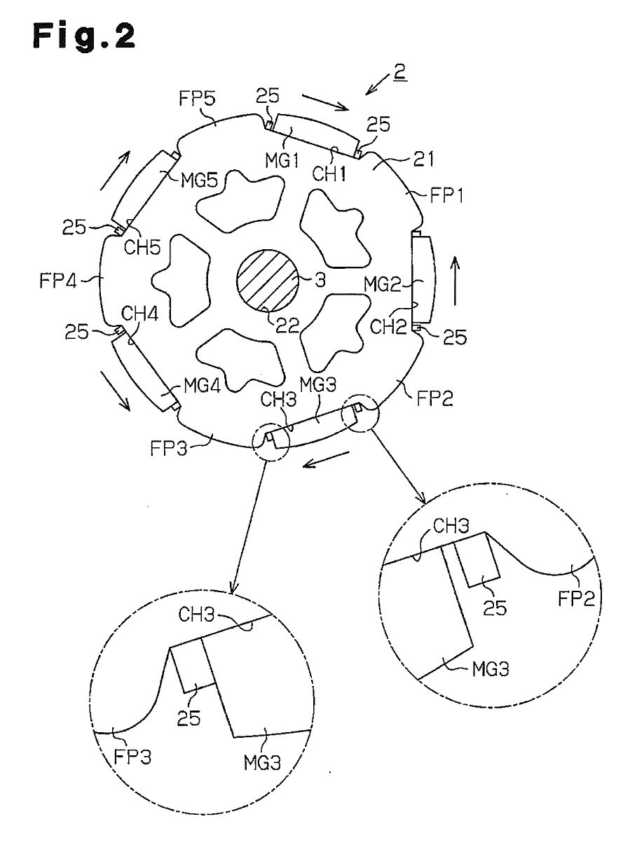

The rotor 2 of a consequent pole structure includes a rotor core 21, which is formed by laminating rotor core pieces 21a made of steel plates. An insertion hole 22 is formed in the center of the rotor core 21 to extend through the rotor 2 in the axial direction of the rotor core 21. The rotary shaft 3 extends through the insertion hole 22, so that the rotor core 21 is fixed to the rotary shaft 3. The rotor core 21 is columnar. Five recesses, which serve as installation portions, are arranged along the circumference of the rotor core 21 at equal angular intervals. The five recesses are referred to as first to fifth recesses CH1 to CH5 in order in the clockwise direction, or the direction of the positive rotation, as viewed in FIGS. 1 and 2.

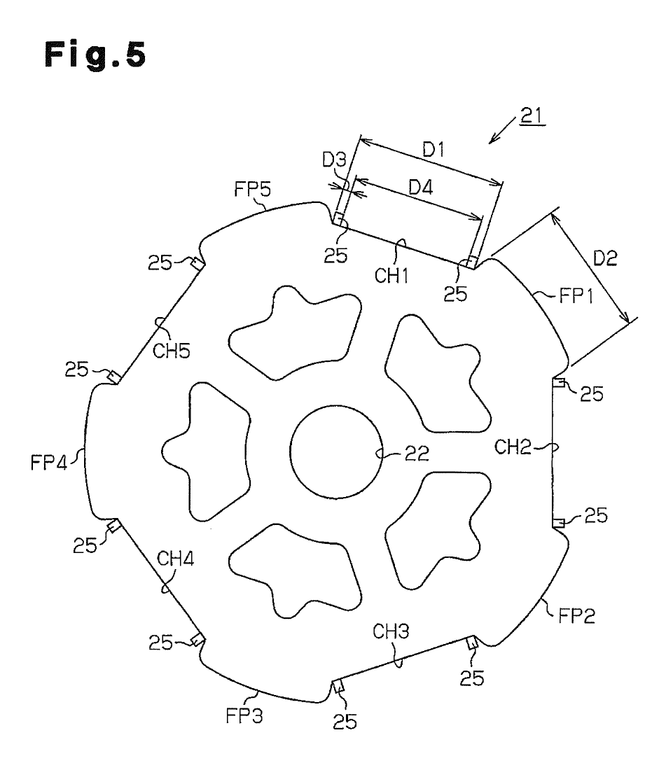

The first to fifth recesses CH1 to CH5 are formed to extend in the axial direction of the rotor core 21. The widths in the circumferential direction of the first to fifth recesses CH1 to CH5, that is, the widths D1 of the bottoms of the first to fifth recesses CH1 to CH5 as viewed in FIG. 5 are the same. The bottom of the first to fifth recesses CH1 to CH5 is a flat surface, which is perpendicular to a line that extends in the radial direction from the center of the surface in the width direction to the axis of the rotary shaft 3.

The first to fifth recesses CH1 to CH5 form five pseudo magnetic poles each located between adjacent pair of the recesses CH1 to CH5. The five pseudo magnetic poles are hereinafter referred to as first to fifth pseudo magnetic poles FP1 to FP5.

As shown in FIG. 5, the first pseudo magnetic pole FP1 is formed between the first recess CH1 and the second recess CH2, and the second pseudo magnetic pole FP2 is formed between the second recess CH2 and the third recess CH3. Also, the third pseudo magnetic pole FP3 is formed between the third recess CH3 and the fourth recess CH4, and the fourth pseudo magnetic pole FP4 is formed between the fourth recess CH4 and the fifth recess CH5. Further, the fifth pseudo magnetic pole FP5 is formed between and the fifth recess CH5 and the first recess CH1.

The widths D2 in the circumferential direction of the pseudo magnetic poles FP1 to FP5 each formed between adjacent pair of the recesses CH1 to CH5 are the same. The width D2 is smaller than the width D1 in the circumferential direction of the recesses CH1 to CH5.

As shown in FIG. 5, positioning members 25 are fixed to both ends in the width direction of the bottom of each of the first to fifth recesses CH1 to CH5. The positioning members 25 extend along the axial direction of the rotor core 21. Each positioning member 25, which serves as an engaging portion, is a square rod having a substantially square cross section. A corner of each positioning member 25 between a side and the bottom contacts a valley line where a side of the corresponding one of the pseudo magnetic poles FP1 to FP5 and the bottom of the associated one of the first to fifth recesses CH1 to CH5. The positioning members 25 are fixed to the bottoms of the first to fifth recesses CH1 to CH5 to extend in the axial direction of the rotor core 21.

The widths D3 in the circumferential direction of the positioning members 25 are the same. The width D3 of the positioning members 25 is determined such that the interval D4 between each facing pair of the positioning members 25 is greater than the width D2 in the circumferential direction of the pseudo magnetic poles FP1 to FP5.

After the positioning members 25 are fixed to the bottoms of the recesses CH1 to CH5 at positions adjacent to the sides of the pseudo magnetic poles FP1 to FP5, first to fifth permanent magnets MG1 to MG5, which serve as first magnets, are bonded and fixed to the bottoms of the recesses CH1 to CH5.

Specifically, the first permanent magnet MG1 is fixed to the first recess CH1, and the second permanent magnet MG2 is fixed to the second recess CH2. Also, the third permanent magnet MG3 is fixed to the third recess CH3, and the fourth permanent magnet MG4 is fixed to the fourth recess CH4. Further, the fifth permanent magnet MG5 is fixed to the fifth recess CH5.

The bottoms of the permanent magnets MG1 to MG5 are formed to be flat in correspondence with the bottoms of the recesses CH1 to CH5. The sides in the width direction of each of the permanent magnets MG1 to MG5 are perpendicular to the bottom of the corresponding one of the permanent magnets MG1 to MG5. The sides of each of the permanent magnets MG1 to MG5 are formed to be parallel with each other. The interval between the sides of each of the permanent magnets MG1 to MG5 is the same as the width D2 in the circumferential direction of each of the pseudo magnetic poles FP1 to FP5.

The first to fifth permanent magnets MG1 to MG5 are each a ferrite magnet in the present embodiment. Each of the first to fifth permanent magnets MG1 to MG5 is bonded and fixed to the corresponding one of the recesses CH1 to CH5 such that the south pole of each permanent magnet MG1 to MG5 is located on the radially outer side, and the north pole is located on the radially inner side. That is, first magnetic poles, which are the magnet magnetic poles, are magnetic poles on the radially outer sides of MG1 to MG5 and are south poles. Therefore, second magnetic poles FP1 to FP5, which are the pseudo magnetic poles each formed between an adjacent pair of the permanent magnets MG1 to MG5, function as north poles. As a result, the north poles and the south poles of the rotor 2 are alternately arranged in the circumferential direction, and the number of pairs of poles is set to five. That is, the rotor 2 is a consequent pole rotor having ten magnetic poles.

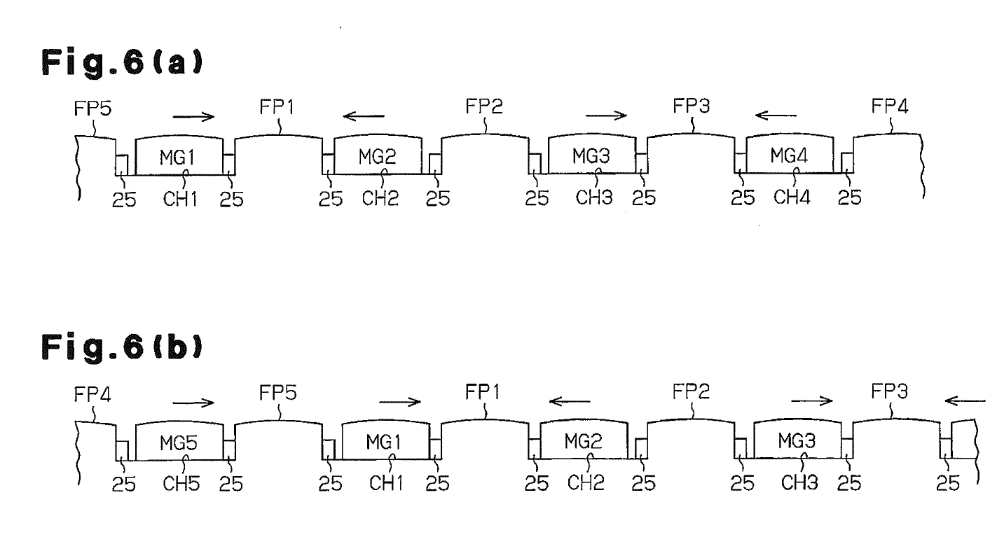

Hereinafter, a method for bonding and fixing the permanent magnets MG1 to MG5 to the recesses CH1 to CH5 will be described with reference to FIGS. 2, 6(a), and 6(b).

The first permanent magnet MG1 is bonded and fixed to the bottom of the first recess CH1 such that the first permanent magnet MG1 contacts the positioning member 25 fixed to the right end of the first recess CH1 as viewed in FIGS. 6(a) and 6(b). Accordingly, the first permanent magnet MG1 is fixed with reference to the right positioning member 25 in the first recess CH1, that is, with reference to the positioning member 25 on the side in the positive rotational direction of the rotor 2, which is the clockwise direction of the first recess CH1 as viewed in FIG. 2. That is, the first permanent magnet MG1 is offset toward the pseudo magnetic pole FP1 in the positive rotational direction of the rotor 2 to be brought into contact with the positioning member 25. In this state, the first permanent magnet MG1 is fixed to the bottom of the first recess CH1.

Next, the second permanent magnet MG2 is bonded and fixed to the bottom of the second recess CH2 such that the second permanent magnet MG2 contacts the positioning member 25 fixed to the left end of the second recess CH2 as viewed in FIGS. 6(a) and 6(b). Accordingly, the second permanent magnet MG2 is fixed with reference to the left positioning member 25 in the second recess CH2, that is, with reference to the positioning member 25 on the side in the inverse rotational direction of the rotor 2, which is the counterclockwise direction of the second recess CH2 as viewed in FIG. 2. That is, the second permanent magnet MG2 is offset toward the pseudo magnetic pole FP1 in the inverse rotational direction of the rotor 2 to be brought into contact with the positioning member 25. In this state, the second permanent magnet MG2 is fixed to the bottom of the second recess CH2.

Next, the third permanent magnet MG3 is bonded and fixed to the bottom of the third recess CH3 such that the third permanent magnet MG3 contacts the positioning member 25 fixed to the right end of the third recess CH3 as viewed in FIGS. 6(a) and 6(b). Accordingly, the third permanent magnet MG3 is fixed with reference to the right positioning member 25 in the third recess CH3, that is, with reference to the positioning member 25 on the side in the positive rotational direction of the rotor 2, which is the clockwise direction of the third recess CH3 as viewed in FIG. 2. That is, the third permanent magnet MG3 is offset toward the pseudo magnetic pole FP3 in the positive rotational direction of the rotor 2 to be brought into contact with the positioning member 25. In this state, the third permanent magnet MG3 is fixed to the bottom of the third recess CH3.

Next, the fourth permanent magnet MG4 is bonded and fixed to the bottom of the fourth recess CH4 such that the fourth permanent magnet MG4 contacts the positioning member 25 fixed to the left end of the fourth recess CH4 as viewed in FIG. 6(a). Accordingly, the fourth permanent magnet MG4 is fixed with reference to the left positioning member 25 in the fourth recess CH4, that is, with reference to the positioning member 25 on the side in the inverse rotational direction of the rotor 2, which is the counterclockwise direction of the fourth recess CH4 as viewed in FIG. 2. That is, the fourth permanent magnet MG4 is offset toward the pseudo magnetic pole FP3 in the inverse rotational direction of the rotor 2 to be brought into contact with the positioning member 25. In this state, the fourth permanent magnet MG4 is fixed to the bottom of the fourth recess CH4.

Next, the fifth permanent magnet MG5 is bonded and fixed to the bottom of the fifth recess CH5 such that the fifth permanent magnet MG5 contacts the positioning member 25 fixed to the right end of the fifth recess CH5 as viewed in FIG. 6(b). Accordingly, the fifth permanent magnet MG5 is fixed with reference to the right positioning member 25 in the fifth recess CH5, that is, with reference to the positioning member 25 on the side in the positive rotational direction of the rotor 2, which is the clockwise direction of the fifth recess CH5 as viewed in FIG. 2. That is, the fifth permanent magnet MG5 is offset toward the pseudo magnetic pole FP5 in the positive rotational direction of the rotor 2 to be brought into contact with the positioning member 25. In this state, the fifth permanent magnet MG5 is fixed to the bottom of the fifth recess CH5.

The first permanent magnet MG1, the third permanent magnet MG3, and the fifth permanent magnet MG5 are offset and bonded to the bottoms of the first, third, and fifth recesses CH1, CH3, and CH5 with reference to the positioning members 25 that are located on the right ends of the first, third and fifth recesses CH1, CH3, and CH5. In contrast, the second permanent magnet MG2 and the fourth permanent magnet MG4 are offset and bonded to the bottoms of the second and fourth recesses CH2 and CH4 with reference to the positioning members 25 that are located on the left ends of the first and second recesses CH2 and CH4.

In other words, the first to fifth permanent magnets MG1 to MG5 are divided such that the offsetting direction of the first magnets in a first group, which includes the first permanent magnet MG1, the third permanent magnet MG3, and the fifth permanent magnet MG5, is different from the offsetting direction of the first magnets in a second group, which includes the second permanent magnet MG2 and the fourth permanent magnet MG4.

Operation of the brushless motor as described above will now be described.

The positioning members 25 are provided at both ends in each of the first to fifth recesses CH1 to CH5, that is, at the end in the direction of the positive rotation and at the end in the direction of the inverse rotation of the rotor 2 in each of the first to fifth recesses CH1 to CH5.

Then, the first permanent magnet MG1, the third permanent magnet MG3, and the fifth permanent magnet MG5 are bonded and fixed to the bottoms of the recesses CH1, CH3, and CH5 with reference to the positioning members 25 that are offset to the ends in the direction of the positive rotation of the rotor 2, which are the right ends of the first, third and fifth recesses CH1, CH3, and CH5.

Also, the second permanent magnet MG2 and the fourth permanent magnet MG4 are offset and bonded to the bottoms of the second and fourth recesses CH2 and CH4 with reference to the positioning members 25 that are located on the ends in the direction of the inverse rotation of the rotor 2, which are the left ends of the first and second recesses CH2 and CH4.

That is, the first to fifth permanent magnets MG1 to MG5 are bonded and fixed such that the first group, which includes the first permanent magnet MG1, the third permanent magnet MG3, and the fifth permanent magnet MG5, is offset in the direction of the positive rotation of the rotor 2, and the second group, which includes the second permanent magnet MG2 and the fourth permanent magnet MG4, is offset in the direction of the inverse rotation of the rotor 2.

Accordingly, the offsetting direction of all the permanent magnets MG1 to MG5 is not set to only one of the directions of the positive rotation and the inverse rotation, but divided into the direction of the positive rotation and the direction of the inverse rotation of the rotor 2.

As a comparison example, if all the permanent magnets MG1 to MG5 are offset in the direction of the positive rotation or the inverse rotation of the rotor 2, the magnetic balance in the pseudo magnetic poles FP1 to FP5 will deteriorate, and the cogging torque will deteriorate.

In contrast, according to the present embodiment, the offsetting directions of the permanent magnets MG1 to MG5 are divided into the direction of the positive rotation of the rotor 2 and the direction of the inverse rotation of the rotor 2. The difference between the number of permanent magnets that are offset in the direction of the positive rotation and the number of permanent magnets that are offset in the direction of the inverse rotation is one. Thus, when the permanent magnets MG1 to MG5 are bonded and fixed, the uneven distribution of magnetism is cancelled in a great number of permanent magnets. That is, the magnetic imbalance of the pseudo magnetic poles FP1 to FP5 is reduced, and the effect of cancelling the cogging torque generated in the pseudo magnetic poles by the cogging torque generated in the magnetic poles of the permanent magnets is increased. As a result, the cogging torque of the rotor is reduced.

Advantages of the above described embodiment will be described below.

(1) The offsetting direction of the first to fifth permanent magnet MG1 to MG5 is not set to only one of the directions of the positive rotation and the inverse rotation, but divided into the direction of the positive rotation and the direction of the inverse rotation of the rotor 2. The difference between the number of permanent magnets that are offset in the direction of the positive rotation and the number of permanent magnets that are offset in the direction of the inverse rotation is one. This reduces displacement of the magnetic balance.

Therefore, when the permanent magnets MG1 to MG5 are bonded and fixed to the rotor core 21, the uneven distribution of magnetism of some of the permanent magnets is cancelled. That is, any pair of magnets that are offset in opposite directions cancel the uneven distribution of magnetism of the other. As a result, the cogging torque of the rotor is reduced.

(2) According to the present embodiment, the rotor core 21 has the first to fifth recesses CH1 to CH5, and the positioning members 25 are located at both ends of the bottom of the first to fifth recesses CH1 to CH5. The offset fixation, in which the first to fifth permanent magnets MG1 to MG5 are divided with respect to the rotor circumferential direction, is performed by causing the first to fifth permanent magnets MG1 to MG5 to contact the positioning members 25.

Therefore, the first to fifth permanent magnets MG1 to MG5 are divided with respect to the rotor circumferential direction and are offset easily and accurately.

Since the positioning members 25 are provided on both ends of the bottom of each of the first to fifth recesses CH1 to CH5, the permanent magnets can be divided to ones that are offset in the positive rotational direction and ones that are offset in the inverse rotational direction of the rotor 2.

### Second Embodiment

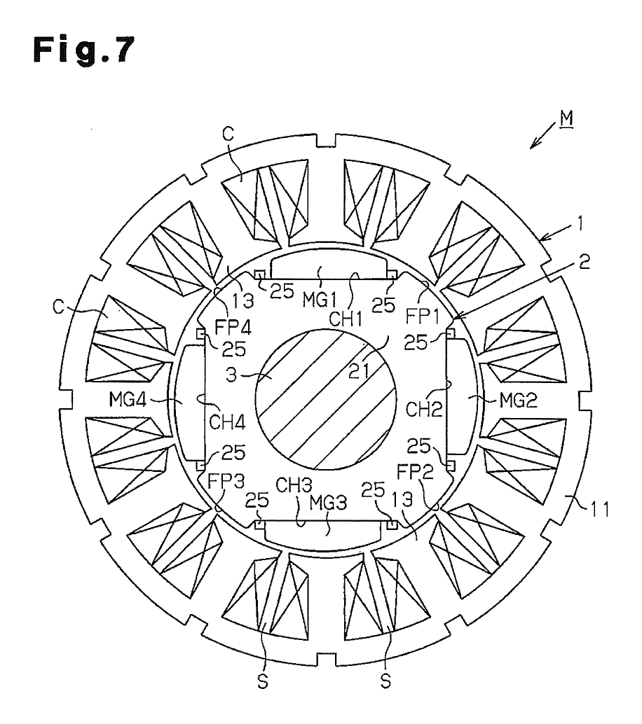

A second embodiment of the present invention will now be described with reference to FIGS. 7 to 9.

As shown in FIG. 7, a brushless motor M of the present embodiment includes a stator 1 and a rotor 2. The stator 1 has twelve slots and coils wound by way of concentrated winding. The rotor 2 is a consequent pole rotor with eight magnetic poles.

The stator 1 further has a stator core 11. Twelve teeth 13 are formed on the stator core 11. Therefore, the number of slots S formed between the teeth 13 is also twelve. Coils C are wound about the teeth 13 by way of concentrated winding. Currents to the three phase coils, which are wound by way of concentrated winding, are controlled, so that a rotating magnetic field is generated in the stator 1. Accordingly, a rotary shaft 3, which is located inside the stator 1, is rotated in a positive direction or in an inverse direction. The positive rotation of the rotor 2 is the clockwise rotation as viewed in FIG. 7. The inverse rotation of the rotor 2 is the counterclockwise rotation as viewed in FIG. 7.

The rotor 2, which is arranged inside the stator 1, has a consequent pole structure as shown in FIG. 7. As in the first embodiment, the rotor 2 includes a rotor core 21, which is formed by laminating rotor core pieces made of steel plates. The rotor core 21 is columnar. Four recesses, which serve as installation portions, are arranged along the circumference of the rotor core 21 at equal angular intervals. The four recesses extend in the axial direction of the rotor core 21. The four recesses are referred to as first to fourth recesses CH1 to CH4 in order in the direction of the positive rotation of the rotor 2, as viewed in FIG. 7.

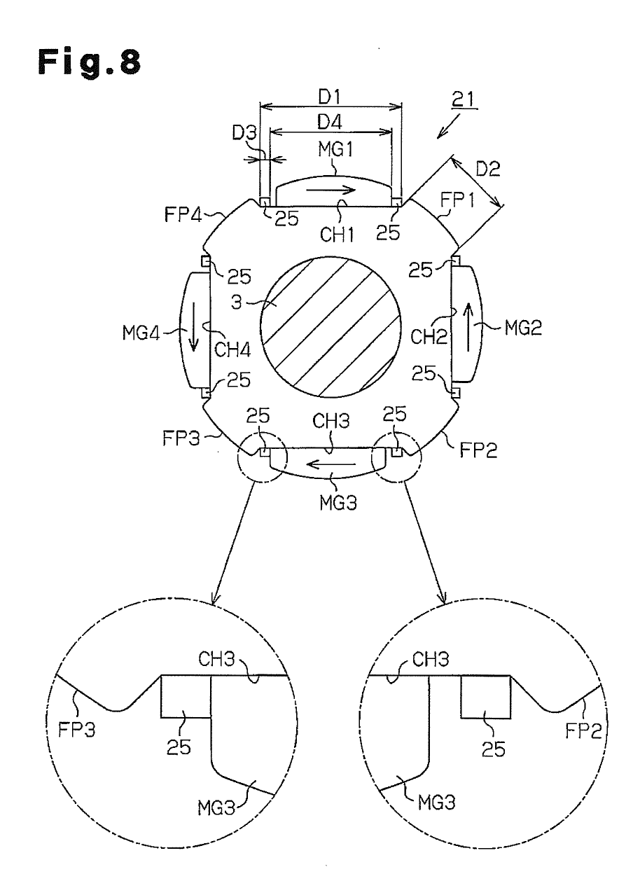

The first to fourth recesses CH1 to CH4 are formed to extend in the axial direction of the rotor core 21. The widths in the circumferential direction of the first to fourth recesses CH1 to CH4, that is, the widths D1 of the bottoms of the first to fourth recesses CH1 to CH4 as viewed in FIG. 8 are the same. The bottom of the first to fourth recesses CH1 to CH4 is a flat surface, which is perpendicular to a line that extends in the radial direction from the center of the surface in the width direction to the axis of the rotary shaft 3.

The first to fourth recesses CH1 to CH4 in the rotor core 21 form four pseudo magnetic poles each located between adjacent pair of the recesses CH1 to CH4. The four pseudo magnetic poles are hereinafter referred to as first to fourth pseudo magnetic poles FP1 to FP4.

As shown in FIG. 8, the first pseudo magnetic pole FP1 is formed between the first recess CH1 and the second recess CH2, and the second pseudo magnetic pole FP2 is formed between the second recess CH2 and the third recess CH3. Also, the third pseudo magnetic pole FP3 is formed between the third recess CH3 and the fourth recess CH4, and the fourth pseudo magnetic pole FP4 is formed between the fourth recess CH4 and the first recess CH1.

The widths D2 in the circumferential direction of the pseudo magnetic poles FP1 to FP4 each formed between adjacent pair of the recesses CH1 to CH4 are the same. The width D2 is smaller than the width D1 in the circumferential direction of the recesses CH1 to CH4.

Positioning members 25 are fixed to both ends in the width direction of the bottom of each of the first to fourth recesses CH1 to CH4. The positioning members 25 extend along the axial direction of the rotor core 21. Each positioning member 25 is a square rod having a substantially square cross section. A corner of each positioning member 25 between a side and the bottom contacts a valley line where a side of the corresponding one of the pseudo magnetic poles FP1 to FP4 and the bottom of the associated one of the first to fourth recesses CH1 to CH4 meet. The positioning members 25 are fixed to the bottoms of the first to fourth recesses CH1 to CH4 to extend in the axial direction of the rotor core 21.

The widths D3 in the circumferential direction of the positioning members 25 are the same. The width D3 of the positioning members 25 is determined such that the interval D4 between each facing pair of the positioning members 25 is greater than the width D2 in the circumferential direction of the pseudo magnetic poles FP1 to FP4.

After the positioning members 25 are fixed to the bottoms of the recesses CH1 to CH4, first to fourth permanent magnets MG1 to MG4 are bonded and fixed to the bottoms of the recesses CH1 to CH4. The first permanent magnet MG1 is fixed to the first recess CH1, and the second permanent magnet MG2 is fixed to the second recess CH2. Also, the third permanent magnet MG3 is fixed to the third recess CH3, and the fourth permanent magnet MG4 is fixed to the fourth recess CH4.

The bottoms of the permanent magnets MG1 to MG4 are formed to be flat in correspondence with the bottoms of the recesses CH1 to CH4. The sides in the width direction of each of the permanent magnets MG1 to MG4 are perpendicular to the bottom of the corresponding one of the permanent magnets MG1 to MG4. The sides of each of the permanent magnets MG1 to MG4 are formed to be parallel with each other. The interval between the sides of each of the permanent magnets MG1 to MG4 is the same as the width D2 in the circumferential direction of each of the pseudo magnetic poles FP1 to FP4.

The first to fourth permanent magnets MG1 to MG4 are each a ferrite magnet in the present embodiment. Each of the permanent magnets MG1 to MG4 is bonded and fixed to the corresponding one of the recesses CH1 to CH4 such that the south pole of each permanent magnet MG1 to MG4 is located on the radially outer side, and the north pole is located on the radially inner side. The magnetic poles on the radially outside, which are south poles in the present embodiment, are referred to as magnet magnetic poles. Therefore, the pseudo magnetic poles FP1 to FP4 each formed between an adjacent pair of the permanent magnets MG1 to MG4 function as north poles. As a result, the north poles and the south poles of the rotor 2 are alternately arranged in the circumferential direction, and the number of pairs of poles is set to four. That is, the rotor 2 is a consequent pole rotor having eight magnetic poles.

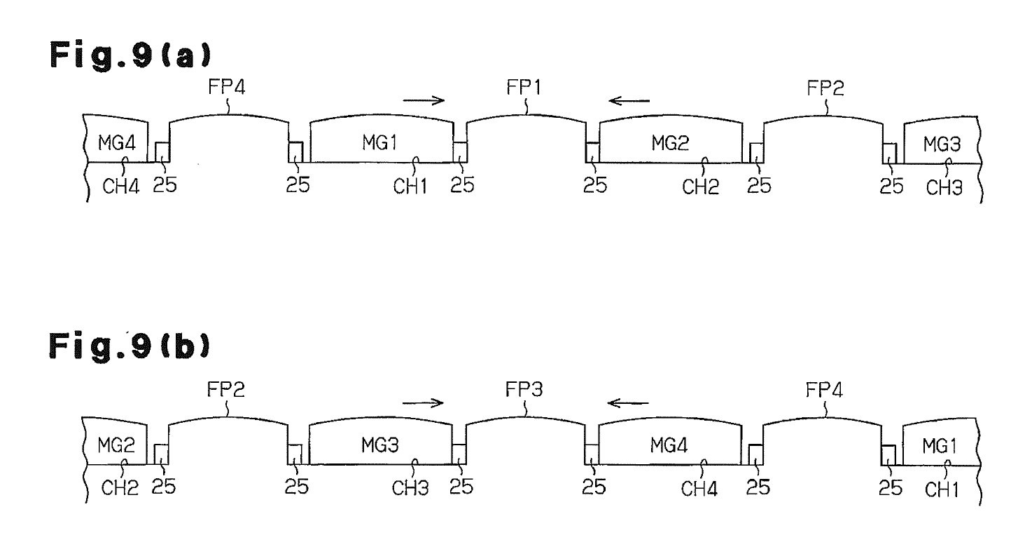

Hereinafter, a method for bonding and fixing the permanent magnets MG1 to MG4 to the recesses CH1 to CH4 will be described with reference to FIGS. 7, 9(a), and 9(b).

The first permanent magnet MG1 is bonded and fixed to the bottom of the first recess CH1 such that the first permanent magnet MG1 contacts the positioning member 25 fixed to the right end of the first recess CH1 as viewed in FIG. 9(a). Accordingly, the first permanent magnet MG1 is fixed to the rotor core 21 with reference to the right positioning member 25 in the first recess CH1, that is, with reference to the positioning member 25 located on the of the positive rotational direction of the rotor 2, which is the clockwise direction of the first recess CH1 as viewed in FIG. 7. That is, the first permanent magnet MG1 is offset toward the pseudo magnetic pole FP1 in the positive rotational direction of the rotor 2 to be brought into contact with the positioning member 25. In this state, the first permanent magnet MG1 is fixed to the bottom of the first recess CH1.

Next, the second permanent magnet MG2 is bonded and fixed to the bottom of the second recess CH2 such that the second permanent magnet MG2 contacts the positioning member 25 fixed to the left end of the second recess CH2 as viewed in FIG. 9(a). Accordingly, the second permanent magnet MG2 is fixed to the rotor core 21 with reference to the left positioning member 25 in the second recess CH2, that is, with reference to the positioning member 25 on the side in the inverse rotational direction of the rotor 2, which is the counterclockwise direction of the second recess CH2 as viewed in FIG. 7. That is, the second permanent magnet MG2 is offset toward the pseudo magnetic pole FP1 in the inverse rotational direction of the rotor 2 to be brought into contact with the positioning member 25. In this state, the second permanent magnet MG2 is fixed to the bottom of the second recess CH2.

Next, the third permanent magnet MG3 is bonded and fixed to the bottom of the third recess CH3 such that the third permanent magnet MG3 contacts the positioning member 25 fixed to the right end of the third recess CH3 as viewed in FIG. 9(b). Accordingly, the third permanent magnet MG3 is fixed to the rotor core 21 with reference to the right positioning member 25 in the third recess CH3, that is, with reference to the positioning member 25 located on the of the positive rotational direction of the rotor 2, which is the clockwise direction of the third recess CH3 as viewed in FIG. 7. That is, the third permanent magnet MG3 is offset toward the pseudo magnetic pole FP3 in the positive rotational direction of the rotor 2 to be brought into contact with the positioning member 25. In this state, the third permanent magnet MG3 is fixed to the bottom of the third recess CH3.

Next, the fourth permanent magnet MG4 is bonded and fixed to the bottom of the fourth recess CH4 such that the fourth permanent magnet MG4 contacts the positioning member 25 fixed to the left end of the fourth recess CH4 as viewed in FIG. 9(b). Accordingly, the fourth permanent magnet MG4 is fixed to the rotor core 21 with reference to the left positioning member 25 in the fourth recess CH4, that is, with reference to the positioning member 25 on the side in the inverse rotational direction of the rotor 4, which is the counterclockwise direction of the fourth recess CH4 as viewed in FIG. 2. That is, the fourth permanent magnet MG4 is offset toward the pseudo magnetic pole FP3 in the inverse rotational direction of the rotor 2 to be brought into contact with the positioning member 25. In this state, the fourth permanent magnet MG4 is fixed to the bottom of the fourth recess CH4.

That is, the first and third permanent magnets MG1, MG3, which form a first group, are offset and bonded to the bottoms of the first and third recesses CH1 and CH3 with reference to the positioning members 25 that are located on the right end of the first and third recesses CH1 and CH3. In contrast, the second and fourth permanent magnets MG2, MG4, which form a second group, are offset and bonded to the bottoms of the second and fourth recesses CH2 and CH4 with reference to the positioning members 25 that are located on the left end of the second and fourth recesses CH2 and CH4.

In other words, the first to fourth permanent magnets MG1 to MG4 are divided such that the offsetting direction in the first group, which includes the first and third permanent magnets MG1, MG3 is different from the offsetting direction in the second group, which includes the second and fourth permanent magnets MG2, MG4.

Operation of the brushless motor as described above will now be described.

The positioning members 25 are provided at both ends in each of the first to fourth recesses CH1 to CH4, that is, at the end in the direction of the positive rotation and at the end in the direction of the inverse rotation of the rotor 2 in each of the first to fourth recesses CH1 to CH4.

Also, the first permanent magnet MG1 and the third permanent magnet MG3 are offset and bonded to the bottoms of the first and third recesses CH1 and CH3 with reference to the positioning members 25 that are located on the ends in the direction of the positive rotation of the rotor 2, which are the right ends of the first and third recesses CH1 and CH3.

Also, the second permanent magnet MG2 and the fourth permanent magnet MG4 are offset and bonded to the bottoms of the second and fourth recesses CH2 and CH4 with reference to the positioning members 25 that are located on the ends in the direction of the inverse rotation of the rotor 2, which are the left ends of the second and fourth recesses CH2 and CH4.

That is, the first to fourth permanent magnets MG1 to MG4 are bonded and fixed such that the group of the first permanent magnet MG1 and the third permanent magnet MG3 is offset in the direction of the positive rotation of the rotor 2, and the group of the second permanent magnet MG2 and the fourth permanent magnet MG4 is offset in the direction of the inverse rotation of the rotor 2.

Accordingly, the offsetting direction of the permanent magnets MG1 to MG4 is not set to only one of the directions of the positive rotation and the inverse rotation, but equally divided into the direction of the positive rotation and the direction of the inverse rotation of the rotor 2.

As a comparison example, if all the permanent magnets MG1 to MG4 are offset in the direction of the positive rotation or the inverse rotation of the rotor 2, the magnetic balance in the pseudo magnetic poles FP1 to FP4 will deteriorate, and the cogging torque will deteriorate.

In contrast, according to the present embodiment, the offsetting direction of the permanent magnets MG1 to MG4 is equally divided into the direction of the positive rotation of the rotor 2 and the direction of the inverse rotation of the rotor 2. This completely cancels the uneven distribution of magnetism generated when the permanent magnets MG1 to MG4 are bonded and fixed. Therefore, the magnetic imbalance of the pseudo magnetic poles FP1 to FP4 is reduced, and the effect of cancelling the cogging torque generated in the pseudo magnetic poles by the cogging torque generated in the magnetic poles of the permanent magnets is increased. As a result, the cogging torque of the rotor is reduced.

Advantages of the above described embodiment will be described below.

(1) The offsetting direction of the first to fourth permanent magnet MG1 to MG4 is not set to only one of the directions of the positive rotation and the inverse rotation, but divided into the direction of the positive rotation and the direction of the inverse rotation. The number of the permanent magnets MG1, MG3, which are offset in the direction of the positive rotation of the rotor 2, is two and equal to the number of the permanent magnets MG2, MG4, which are offset in the direction of the inverse rotation of the rotor 2.

Therefore, when the permanent magnets MG1 to MG4 are bonded and fixed to the rotor core, the uneven distribution of magnetism is cancelled. As a result, the cogging torque of the rotor is reduced.

(2) According to the present embodiment, the rotor core 21 has the first to fourth recesses CH1 to CH4, and the positioning members 25 are located at both ends of the bottom of the first to fourth recesses CH1 to CH4. The offset fixation, in which the first to fourth permanent magnets MG1 to MG4 are divided with respect to the rotor circumferential direction, is performed by causing the first to fourth permanent magnets MG1 to MG4 to contact the positioning members 25.

Therefore, the first to fourth permanent magnets MG1 to MG4 are divided and offset easily and accurately.

Since the positioning members 25 are provided on both ends of the bottom of each of the first to fourth recesses CH1 to CH4, the permanent magnets MG1 to MG4 can be divided to ones that are offset in the positive rotational direction and ones that are offset in the inverse rotational direction of the rotor 2.

The above illustrated embodiments may be modified as follows.

In each of the above embodiments, the positioning members 25 are located at both ends of the bottom of each of the first to fifth recesses CH1 to CH5. However, the positioning members 25 may be located only at the side of the bottom toward which the permanent magnet is offset.

This configuration reduces the number of the positioning members 25.

The positioning members 25 at both ends may be omitted. In this case, a corner of each permanent magnet that is formed by a side in the offsetting direction and the bottom contacts a valley line where a side of the corresponding one of the pseudo magnetic poles FP1 to FP5 and the bottom of the associated one of the first to fifth recesses CH1 to CH5 meet.

In the embodiments illustrated above, the length of the positioning members 25 in the axial direction of the rotor core 21 matches with the length of the rotor core 21 in the axial direction. However, the length of the positioning members 25 may be reduced as long as the offset permanent magnets MG1 to MG5 do not chatter.

In the first embodiment, the present invention is applied to the rotor 2, which is a consequent pole rotor having ten magnetic poles. However, the present invention may be applied to any type of consequent pole rotor as long as the number of its magnetic poles is represented by an expression 4P+2, where P is an integer, the number of the permanent magnets is represented by (2P+1), and the permanent magnets are divided into a first group having permanent magnets the number of which is represented by (P+1) and a second group having permanent magnets the number of which is represented by P.

In the second embodiment, the present invention is applied to the rotor 2, which is a consequent pole rotor having eight magnetic poles. However, the present invention is not limited to this configuration. For example, the present invention may be applied to any type of consequent pole rotor as long as the number of its magnetic poles is represented by 4P, where P is an integer, the number of the permanent magnets is represented by 2P, and the permanent magnets are divided into a first group and a second group each having permanent magnets the number of which is represented by P, and the magnets in one group are offset in the direction opposite to the offsetting direction of the magnets in the other group.

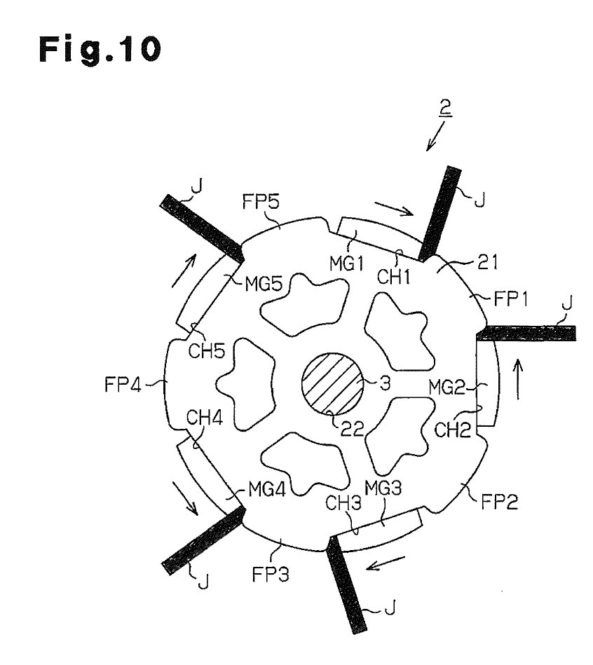

In the first embodiment, the permanent magnets MG1 to MG5 are divided and fixed after being offset using the positioning members 25. Instead, the permanent magnets MG1 to MG5 may be divided and fixed after being offset using jigs J as shown in FIG. 10.

Specifically, each jig J is arranged at an end of one of the first to fifth recesses CH1 to CH5 toward which the associated one of the permanent magnets MG1 to MG5 is offset. The surface of each of the permanent magnets MG1 to MG5 that faces in the offsetting direction is caused to contact the corresponding jig J before the permanent magnets MG1 to MG5 are fixed. In this case, since the positioning members 25 are not necessary, the number of components is reduced.

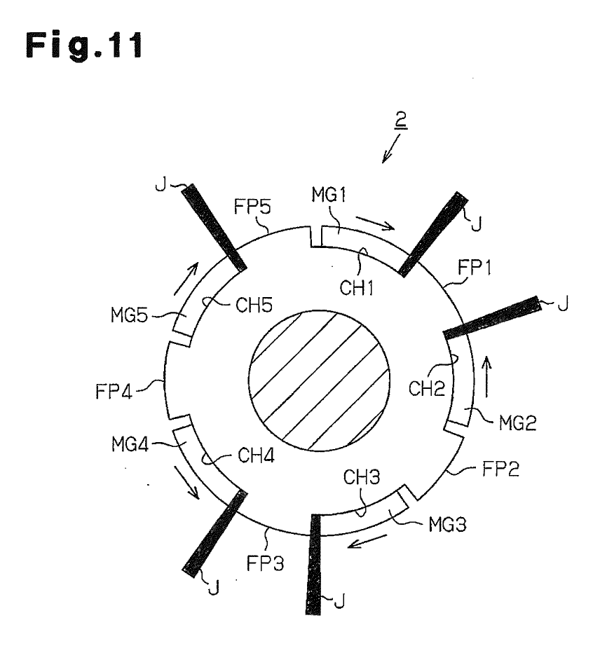

FIG. 11 illustrates a rotor 2 that has first to fifth recesses CH1 to CH5 having bottoms curved to be arcuate, and permanent magnets MG1 to MG5 having curved inner surfaces in accordance with the arcuate bottoms of the recesses CH1 to CH5. In this case, it is difficult to arrange positioning members 25 with high accuracy. Therefore, when it is difficult to accurately arrange the permanent magnet MG1 to MG5, permanent magnets can be highly accurately divided and offset using the jigs J.

As a matter of course, the jigs J may be used for the consequent pole rotor 2 having eight magnetic poles as in the second embodiment to divide and offset the permanent magnets MG1 to MG4.

The above embodiments are applied to brushless motors. However, the above embodiments may be applied to motors having brushes, which rotate in positive and inverse directions.

The above illustrated embodiments are applied to a surface permanent magnet motor (SPM), which has no brushes. However, the embodiments may be applied to an interior permanent magnet motors (IPM), which has no brushes.

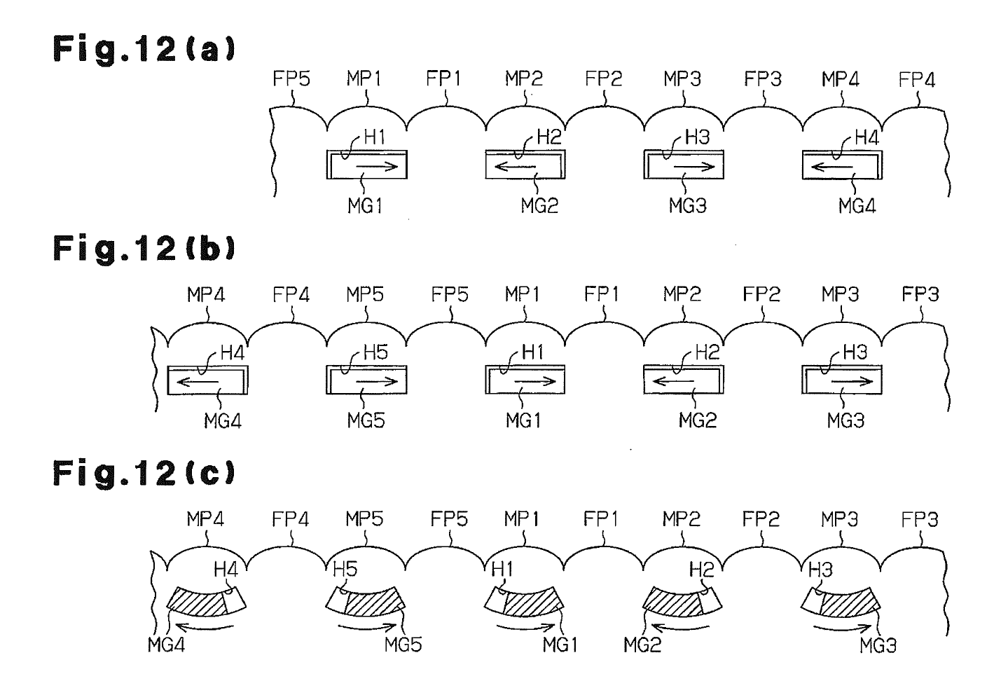

For example, in an interior permanent magnet type brushless motor having ten magnetic poles, first to fifth through holes H1 to H5 extending in the axial direction may be formed in first to fifth magnet magnetic poles MP1 to MP5 each formed between a corresponding pair of first to fifth pseudo magnetic poles FP1 to FP5 as shown in FIGS. 12(a) to 12(c).

As shown in FIGS. 12(a) and 12(b), the first to fifth through holes H1 to H5 each have a rectangular cross section and a size sufficient for receiving the first to fifth permanent magnets MG1 to MG5. Also, as shown in FIG. 12(c), the first to fifth through holes Hi to H5 may each have an arcuate cross section bulging toward the axis of the rotor and a size sufficient for receiving the first to fifth permanent magnets MG1 to MG5. The first to fifth permanent magnets MG1 to MG5 are received in the through holes Hi to H5 and are offset before being fixed. In FIG. 12(c), the space between a side of each through hole H1 to H5 and the corresponding one of the permanent magnets MG1 to MG5 is exaggerated for purposes of illustration.

At this time, as in the first embodiment, the first to fifth permanent magnets MG1 to MG5 are divided and offset within the first to fifth through holes H1 to H5.

That is, the first permanent magnet MG1, the third permanent magnet MG3, and the fifth permanent magnet MG5 are bonded to the first, third and fifth through holes H1, H3, H5, respectively, after being offset toward sides of the first, third and fifth through holes H1, H3, H5 that are close to the first pseudo magnetic pole FP1, the third pseudo magnetic pole FP3, the fifth pseudo magnetic pole FP5. That is, the first, third and fifth permanent magnets MG1, MG3 and MG5 are offset in the positive rotational direction.

The second permanent magnet MG2 and the fourth permanent magnet MG4 are bonded to sides of the second and fourth through holes H2, H4 that are close to the first pseudo magnetic pole FP1 and the third pseudo magnetic pole FP3, that is, to a side facing in the inverse rotational direction.

Therefore, when applied to an interior permanent magnet type brushless motor, the same advantages as the above illustrated embodiments are achieved.

Each of the above illustrated embodiments and the modifications thereof is applied to a consequent pole rotor 2, but may be applied to a full magnet type rotor, in which permanent magnets having different polarities on the outer surfaces are alternately arranged along the circumference of a rotor 2.

One example of a full magnet type rotor will now be described. Since the stator in the following example is substantially the same as the stator in the above described embodiments and the modifications thereof, the descriptions and drawings related to the stator are all omitted. With regard to the rotor, the same reference numerals are given to components that are the same as those in the above illustrated embodiments and the modifications thereof, and drawings and all or part of the explanations are omitted.

### Third Embodiment

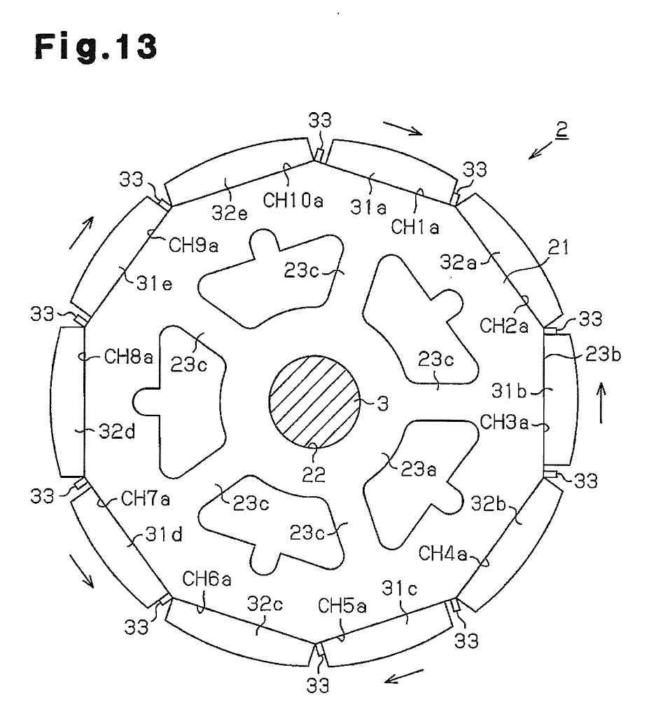

As shown in FIG. 13, a rotor 2 is a full magnet type rotor. That is, the rotor 2 includes a rotor core 21. An insertion hole 22 is formed in a center of the rotor core 21 to extend through the rotor 2 in the axial direction of the rotor core 21. The rotary shaft 3 extends through and is fixed to the insertion hole 22. The rotor core 21 is columnar. Ten flat surface portions are arranged along the circumference of the rotor core 21 at equal angular intervals. The ten flat surface portions are referred to as first to tenth flat surface portions CH1a to CH10a in order in the clockwise direction, or the direction of the positive rotation of the rotor 2 as viewed in FIG. 13.

South pole permanent magnets 31a to 31e, which serve as first magnets, are bonded and fixed to the first flat surface portion CH1a, the third flat surface portion CH3a, the fifth flat surface portion CH5a, the seventh flat surface portion CH7a, and the ninth flat surface portion CH9a, respectively. The south pole permanent magnets 31a to 31e are bonded and fixed such that the radially outside magnetic pole is the south pole, and the radially inside magnetic pole, which faces the flat surface portion CH1a, CH3a, CH5a, CH7a, CH9a, is the north pole. That is, the south pole permanent magnets 31a to 31e form the first magnets, which are magnet magnetic poles.

North pole permanent magnets 32a to 32e, which are second magnets, are bonded and fixed to the second flat surface portion CH2a, the fourth flat surface portion CH4a, the sixth flat surface portion CH6a, the eighth flat surface portion CH8a, and the tenth flat surface portion CH10a, respectively. That is, the north pole permanent magnets 32a to 32e form different polarity magnets, which have magnetic polarities different from those of the south pole permanent magnets 31a to 31e. The north pole permanent magnets 32a to 32e are bonded and fixed to the rotor such that the radially outside magnetic poles are the north poles, and the radially inside magnetic poles, which face the flat surface portions CH2a, CH4a, CH6a, CH8a, CH10a, are the south poles. The radially outside magnetic poles of the north pole permanent magnets 32a to 32e form second magnetic poles. The second magnetic poles are also referred to as different magnetic poles, which are different from the radially outside magnetic poles of the south pole permanent magnets 31a to 31e. The second flat surface portion CH2a, the fourth flat surface portion CH4a, the sixth flat surface portion CH6a, the eighth flat surface portion CH8a, and the tenth flat surface portion CH10a are formed such that the width in the circumferential direction in the rotor 2 of the north pole permanent magnets 32a to 32e is equal to the width in the circumferential direction of the rotor 2 of the second flat surface portion CH2a, the fourth flat surface portion CH4a, the sixth flat surface portion CH6a, the eighth flat surface portion CH8a, and the tenth flat surface portion CH10a.

As shown in FIG. 13, positioning members 33, which extend in the axial direction, are fixed to both circumferential ends of each of the first flat surface portion CH1a, the third flat surface portion CH3a, the fifth flat surface portion CH5a, the seventh flat surface portion CH7a, and the ninth flat surface portion CH9a. The positioning members 33 are fixed such that the widths between the positioning members 33 on the first flat surface portion CH1a, the third flat surface portion CH3a, the fifth flat surface portion CH5a, the seventh flat surface portion CH7a, and the ninth flat surface portion CH9a are the same.

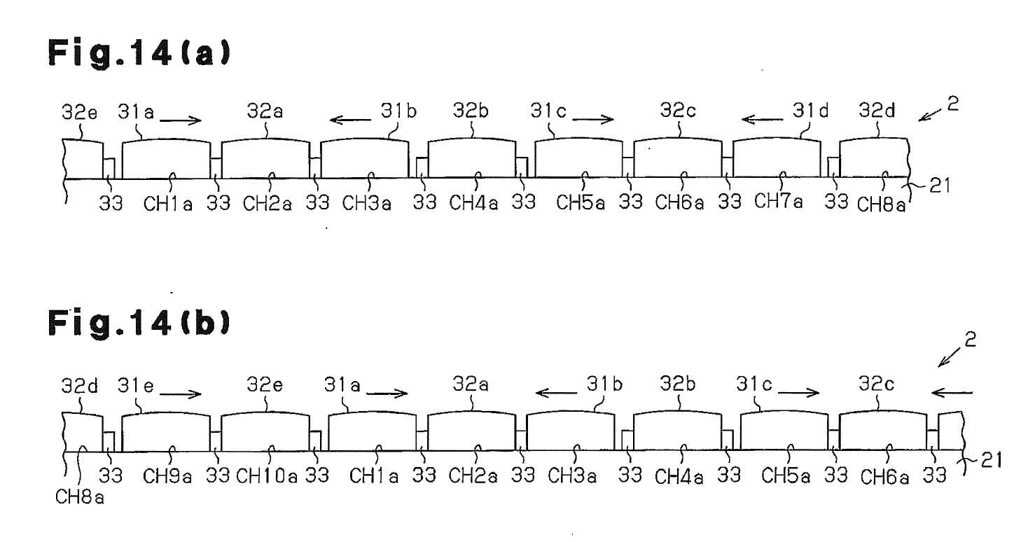

Hereinafter, a method for bonding and fixing the magnets 31a to 32e to the flat surface portions CH1 to CH10 will be described with reference to FIGS. 13 and 14.

First, the north pole permanent magnets 32a to 32e, which form the second magnetic poles, or the different magnetic poles, are fixed to the second flat surface portion CH2a, the fourth flat surface portion CH4a, the sixth flat surface portion CH6a, the eighth flat surface portion CH8a, and the tenth flat surface portion CH10a, respectively.

Next, the south pole permanent magnet 31a is bonded and fixed to the first flat surface portion CH1a such that the south pole permanent magnet 31a contacts the positioning member 33 fixed to the right end of the first flat surface portion CH1a as viewed in FIGS. 14(a) and 14(b). Accordingly, the south pole permanent magnet 31a is fixed to the rotor core 21 with reference to the right positioning member 33 on the first flat surface portion CH1a, that is, with reference to the positioning member 33 on the side in the positive rotational direction of the rotor 2, which is the clockwise direction of the first flat surface portion CH1a as viewed in FIG. 13. That is, the south pole permanent magnet 31a is offset in the direction of the positive rotation of the rotor 2 to be brought into contact with the positioning member 33 and fixed to the first flat surface portion CH1a.

Next, the south pole permanent magnet 31b is bonded and fixed to the third flat surface portion CH3a such that the south pole permanent magnet 31b contacts the positioning member 33 fixed to the left end of the third flat surface portion CH3a as viewed in FIGS. 14(a) and 14(b). Accordingly, the south pole permanent magnet 31b is fixed to the rotor core 21 with reference to the left positioning member 33 on the third flat surface portion CH3a, that is, with reference to the positioning member 33 on the side in the inverse rotational direction of the rotor 2, which is the counterclockwise direction of the third flat surface portion CH3a as viewed in FIG. 13. That is, the south pole permanent magnet 31b is offset in the direction of the inverse rotation of the rotor 2 to be brought into contact with the positioning member 33 and fixed to the third flat surface portion CH3a.

Next, the south pole permanent magnet 31c is bonded and fixed to the fifth flat surface portion CH5a such that the south pole permanent magnet 31c contacts the positioning member 33 fixed to the right end of the fifth flat surface portion CH5a as viewed in FIGS. 14(a) and 14(b). Accordingly, the south pole permanent magnet 31c is fixed to the rotor core 21 with reference to the right positioning member 33 on the fifth flat surface portion CH5a, that is, with reference to the positioning member 33 on the side in the positive rotational direction of the rotor 2, which is the clockwise direction of the fifth flat surface portion CH5a as viewed in FIG. 13. That is, the south pole permanent magnet 31c is offset in the direction of the positive rotation of the rotor 2 to be brought into contact with the positioning member 33 and fixed to the fifth flat surface portion CH5a.

Next, the south pole permanent magnet 31d is bonded and fixed to the seventh flat surface portion CH7a such that the south pole permanent magnet 31d contacts the positioning member 33 fixed to the left end of the seventh flat surface portion CH7a as viewed in FIG. 14(a). Accordingly, the south pole permanent magnet 31d is fixed to the rotor core 21 with reference to the left positioning member 33 on the seventh flat surface portion CH7a, that is, with reference to the positioning member 33 on the side in the inverse rotational direction of the rotor 2, which is the counterclockwise direction of the seventh flat surface portion CH7a as viewed in FIG. 13. That is, the south pole permanent magnet 31d is offset in the direction of the inverse rotation of the rotor 2 to be brought into contact with the positioning member 33 and fixed to the seventh flat surface portion CH7a.

Next, the south pole permanent magnet 31e is bonded and fixed to the ninth flat surface portion CH9a such that the south pole permanent magnet 31e contacts the positioning member 33 fixed to the right end of the ninth flat surface portion CH9a as viewed in FIG. 14(b). Accordingly, the south pole permanent magnet 31e is fixed to the rotor core 21 with reference to the right positioning member 33 on the ninth flat surface portion CH9a, that is, with reference to the positioning member 33 on the side in the positive rotational direction of the rotor 2, which is the clockwise direction of the ninth flat surface portion CH9a as viewed in FIG. 13. That is, the south pole permanent magnet 31e is offset in the direction of the positive rotation of the rotor 2 to be brought into contact with the positioning member 33 and fixed to the ninth flat surface portion CH9a.

That is, the south pole permanent magnets 31a, 31c, 31e are offset and bonded to the first, fifth and ninth flat surface portions CH1a, Ch5a, and CH9a with reference to the positioning members 33 that are located on the right ends of the first, fifth and ninth flat surface portions CH1a, CH5a, CH9a. In contrast, the remaining south pole permanent magnets 31b and 31d are offset and bonded to the rotor with reference to the positioning members 33 that are located on the left ends of the third and seventh flat surface portions CH3a and CH7a.

In other words, the south pole permanent magnets 31a to 31e are divided such that the offsetting direction of the first magnets in a first group, which includes the south pole permanent magnet 31a, the south pole permanent magnet 31c, and the south pole permanent magnet 31e, is different from the offsetting direction of the first magnets in a second group, which includes the south pole permanent magnet 31b and the south pole permanent magnet 31d.

According to the above configuration, all the south pole permanent magnets 31a to 31e is not set to only one of the directions of the positive rotation and the inverse rotation, but divided into the direction of the positive rotation and the direction of the inverse rotation of the rotor 2.

As an comparison example, if all the south pole permanent magnets 31a to 31e are offset in the direction of the positive rotation or the inverse rotation of the rotor 2, the magnetic balance in the north pole permanent magnets 32a to 32e, which are different magnetic poles, or the second magnetic poles, will deteriorate, and the cogging torque will deteriorate. In contrast, according to the present embodiment, the offsetting direction of the south pole permanent magnets 31a to 31e is divided into the direction of the positive rotation of the rotor 2 and the direction of the inverse rotation of the rotor 2. The difference between the number of the south pole permanent magnets 31a, 31c, 31e, which are offset in the direction of the positive rotation, and the number of south pole permanent magnets 31b, 31d, which are offset in the direction of the inverse rotation, is one. When the south pole permanent magnets 31a to 31e are bonded and fixed, the uneven distribution of magnetism is cancelled in a great number of permanent magnets. That is, the magnetic imbalance of the north permanent magnets 32a to 32e, which are different magnetic poles, or the second magnetic poles, is reduced, and the effect of cancelling the cogging torque of the north pole permanent magnets as the second magnetic poles by the cogging torque of the south pole permanent magnets as the first magnetic poles is increased. As a result, the cogging torque of the rotor is reduced.

In this modified embodiment, a ten pole rotor having two different sets of five magnetic poles has been described. However, the present invention may be applied to any type of full magnet type rotor as long as the number of its magnetic poles is represented by an expression 4P+2, where P is an integer, the number of the permanent magnets of one magnetic pole is represented by (2P+1), and the permanent magnets are divided into a first group having permanent magnets the number of which is represented by (P+1) and a second group having permanent magnets the number of which is represented by P. The present invention may also be applied to any type of full magnet type rotor as long as the number of its magnetic poles is represented by 4P, where P is an integer, the number of the permanent magnets forming one magnetic pole is represented by 2P, and the permanent magnets are divided into a first group and a second group each having permanent magnets the number of which is represented by P, and the magnets in one group are offset in the direction opposite to the offsetting direction of the magnets in the other group.

### Fourth Embodiment

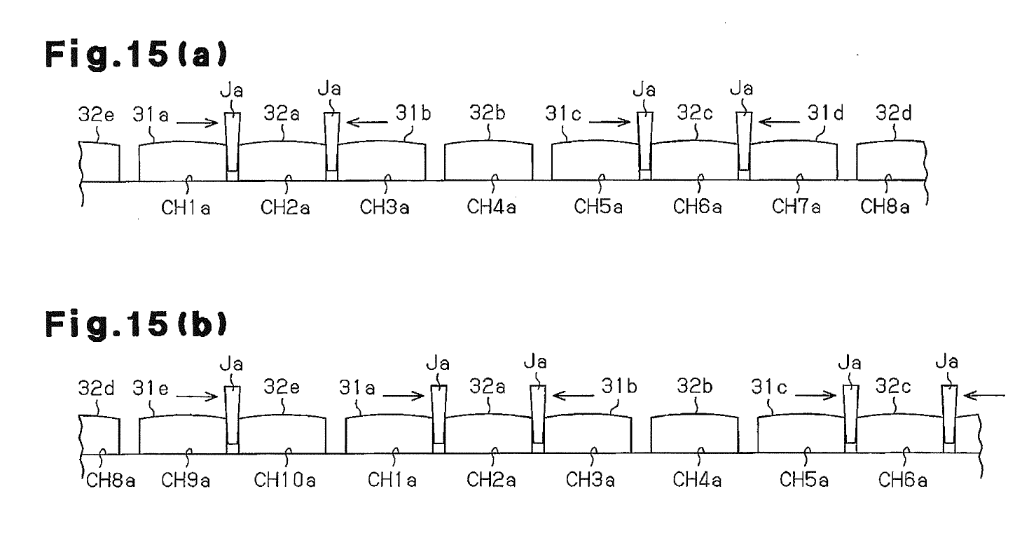

In the third embodiment, the south pole permanent magnets 31a to 31e are divided and fixed after being offset using the positioning members 33. Instead, the south pole permanent magnets 31a to 31e may be divided and fixed after being offset using jigs Ja as shown in FIG. 15. Specifically, each jig Ja is arranged at an end of one of the first flat surface portion CH1a, the third flat surface portion CH3a, the fifth flat surface portion CH5a, the seventh flat surface portion CH7a, and the ninth flat surface portion CH9a toward which the associated one of the south pole permanent magnets 31a to 31e is offset. That is, the jigs Ja are arranged on the sides in the positive rotational direction of the first flat surface portion CH1a, the fifth flat surface portion CH5a, and the ninth flat surface portion CH9a and on the sides in the inverse rotational direction of the third flat surface portion CH3a and the seventh flat surface portion CH7a. The south pole permanent magnets 31a to 31e are each offset toward the corresponding one of the jigs Ja, so that the south pole permanent magnets 31a to 31e are brought into contact with the jigs Ja to be positioned in and fixed to the rotor. In this case, since the positioning members 33 are not necessary, the number of components is reduced.

### Fifth Embodiment

The third and fourth embodiments are applied to surface permanent magnet motors (SPM), which have no brushes. However, the third and fourth embodiments may be applied to an interior permanent magnet motors (IPM), which has no brushes.

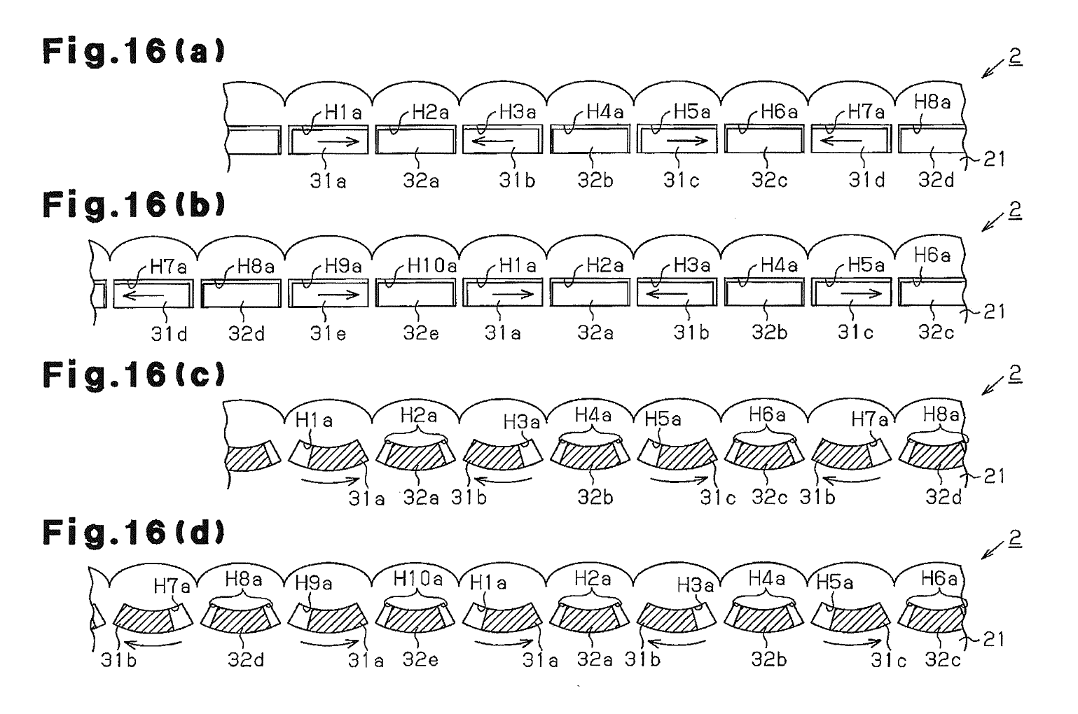

For example, as shown in FIGS. 16(a) to 16(d), a full magnet type rotor having ten magnetic poles may have first to tenth through holes H1a to H10a, which are arranged at equal intervals along the circumference of a rotor core 21 and extend through the rotor core 21 in the axial direction.

North pole magnets 32a to 32e are inserted into the second through hole H2a, the fourth through hole H4a, the sixth through holes H6a, the eighth through holes H8a, and the tenth through holes H10a, respectively. As shown in FIGS. 16(a) to 16(c), the north pole magnets 32a to 32e are each positioned in the circumferential center of the corresponding one of the through holes H2a, H4a, H6a, H8a, H10a. South pole magnets 31a to 31e are inserted into the first through hole H1a, the third through hole H3a, the fifth through holes H5a, the seventh through holes H7a, and the ninth through holes H9, respectively, and fixed after being offset. In FIGS. 16(a) and 16(b), the first to tenth through holes H1 to H10 each have a rectangular cross section and a size sufficient for receiving the south pole magnets 31a to 31e and the north pole magnets 32a to 32e. In FIGS. 16(c) and 16(d), the first to tenth through holes H1 to H10 each have an arcuate cross section bulging toward the axis of the rotor and a size sufficient for receiving the south pole magnets 31a to 31e and the north pole magnets 32a to 32e. At this time, as in the third embodiment, the south pole magnets 31a to 31e are divided and offset within the first through hole H1a, the third through hole H3a, the fifth through hole H5a, the seventh through hole H7a, and the ninth through hole H9a. In FIGS. 16(c) and 16(d), the space between a side of each through hole H1 to H10 and the corresponding one of the permanent magnets 31a to 32e is exaggerated for purposes of illustration.

That is, as shown in FIGS. 16(a) to 16(d), the south pole permanent magnet 31a, the south pole permanent magnet 31c, and the south pole permanent magnet 31e are bonded to the through holes H1a, H3a, H5a, respectively, after being offset toward sides of the through holes H1a, H3a, H5a that are close to the north pole permanent magnet 32a, the north pole permanent magnet 32c, and the north pole permanent magnet 32e. That is, the south pole permanent magnets 31a, 31c, and 31e are offset in the positive rotational direction. That is, the south pole magnets 31a, 31c, 31e, which form the first group, are divided to the direction of the positive rotation of the rotor 2.

As shown in FIGS. 16(a) to 16(d), the south pole permanent magnets 31b and the south pole permanent magnets 31d are bonded and fixed to sides of the third and seventh through holes H3a, H7a that are sides close to the corresponding one of the north pole permanent magnets 32a and the north pole permanent magnets 32c, that is, a side facing in the direction of the inverse rotation. That is, the south pole magnets 31b, 31d, which form the second group, are divided to the direction of the inverse rotation of the rotor 2.

Therefore, when applied to an interior permanent magnet type brushless motor, the same advantages as the above illustrated third embodiment are achieved.

In FIG. 13, the rotor core 21 has a central cylindrical portion 23a, an outer cylindrical portion 23b, and spoke portions 23c, which connects the cylindrical portions 23a and 23b to each other. The above described embodiments and modifications thereof may be configured such that each of the south pole permanent magnets 31a to 31e are offset with reference to the spoke portions 23c. The central cylindrical portion 23a surrounds the insertion hole 22 of the rotor core 21, and the outer cylindrical portion 23b is located outside of the central cylindrical portion 23a. That is, the south pole permanent magnets 31a to 31e may be fixed to the rotor after dividing the south pole permanent magnets 31a to 31e into two groups. Specifically, the south pole permanent magnets in one group are offset in one circumferential direction of the rotor with reference to center lines of the spoke portions 23c in the width direction, and the south pole permanent magnets in the other group are offset in the other direction. This configuration eliminates the necessity for the positioning members 33.

The rotors in the above embodiments and the modifications thereof are inner rotors, in which the stator 1 is located on the radially outer side, and the rotor 2 is located on the radially inner side. However, the present invention may be applied to an outer rotor, which is located radially outside a stator.

1. A motor comprising a rotor, wherein the rotor includes:
a rotor core, which defines an axial direction and a rotor circumferential direction;
a plurality of first magnetic poles, which are magnet magnetic poles, the first magnetic poles being formed in the rotor core by a plurality of first magnets, which are permanent magnets and arranged at predetermined intervals in the rotor circumferential direction, the first magnets being elongated in the axial direction; and
a plurality of second magnetic poles provided in the rotor core are alternately arranged with the first magnetic poles in the rotor circumferential direction, the second magnetic poles being different magnetic poles that are formed either by pseudo magnetic poles located between the first magnets or by second magnets, which are permanent magnets having a different polarity from that of the first magnets, wherein
the rotor core has installation portions, in which the first magnets are arranged, the installation portions being larger than the first magnets,
the first magnets are divided into a first group and a second group,
the first magnets in the first group are fixed to corresponding ones of the installation portions to be offset in the positive rotational direction of the rotor toward the second magnetic poles, and
the first magnets in the second group are fixed to corresponding ones of the installation portions to be offset in the inverse rotational direction of the rotor toward the second magnetic poles.

2. The motor according to claim 1, wherein
engaging portions for engaging with the first magnets in the rotor circumferential direction are provided in the installation portions,
the first magnets in the first group are fixed to the installation portions to be offset in the positive rotational direction of the rotor and to be brought into contact with the engaging portions, and
the first magnets in the second group are fixed to the installation portions to be offset in the inverse rotational direction of the rotor and to be brought into contact with the engaging portions.

3. The motor according to claim 2, wherein
when P represents an integer, the number of poles of the rotor is expressed by 4P, and the number of the first magnets is expressed by 2P,
the first magnets, the number of which is expressed by 2P, are divided into the first group and the second group each having first magnets the number of which is expressed by P,
the first magnets in the first group are fixed to the installation portions to be offset in the positive rotational direction of the rotor toward the second magnetic poles and to be engaged with the engaging portions, and
the first magnets in the second group are fixed to the installation portions to be offset in the inverse rotational direction of the rotor toward the second magnetic poles and to be brought in to contact with the engaging portions.

4. The motor according to claim 2, wherein
when P represents an integer, the number of poles of the rotor is expressed by 4P+2, and the number of the first magnets is expressed by 2P+1,
the first magnets, the number of which is expressed by 2P+1, are divided into the first group having first magnets, the number of which is expressed by P+1, and the second group having first magnets, the number of which is expressed by P,
the first magnets in the first group are fixed to the installation portions to be offset in the positive rotational direction of the rotor toward the second magnetic poles and to be brought into contact with the engaging portions, and
the first magnets of second group are fixed to the installation portions to be offset in the inverse rotational direction of the rotor toward the second magnetic poles and to be brought into contact with the engaging portions.

5. The motor according to any one of claims 2, wherein the engaging portions are located on both ends in the rotor circumferential direction of each installation portion.

6. The motor according to any one of claims 2, wherein
the installation portions each have a pair of ends in the rotor circumferential direction, and
of the ends in the rotor circumferential direction of the installation portions, the engaging portions are located at the ends toward which the first magnets are offset.

7. The motor according to any one of claims 2, wherein
the motor has a stator, and
the rotor is an inner rotor, which is located inward of the stator.

8. The motor according to any one of claims 2, wherein
the motor has a stator, and
the rotor is an outer rotor, which is located outward of the stator.

9. A method for manufacturing a rotor, the method comprising:
preparing a rotor core, which defines an axial direction and a rotor circumferential direction;
forming, in the rotor core, a plurality of installation portions in which a plurality of first magnets, which are permanent magnets, are arranged, the installation portions being larger than the first magnets, and each installation portion having ends in the rotor circumferential direction;
dividing the first magnets into a first group and a second group, the first magnets being elongated in the axial direction;
placing a jig at the end in the positive rotational direction of each installation portion;
offsetting surfaces of the first magnets in the first group such that the surfaces contact the jigs, and fixing the first magnets in the first group to the installation portions;
placing a jig at end in the negative rotational direction of each installation portion;
offsetting the first magnets in the second group to contact the jigs, and fixing the first magnets in the second group to the installation portions, such that the first magnets are located on the rotor core to be arranged in the rotor circumferential direction at predetermined intervals, and that the first magnets form a plurality of first magnetic poles, which are magnet magnetic poles; and
forming a plurality of second magnetic poles in the rotor core to be alternately arranged with the first magnetic poles in the rotor circumferential direction, the second magnetic poles being formed either by pseudo magnetic poles located between the first magnets or by second magnets, which are permanent magnets having a different polarity from that of the first magnets.

10. The method for manufacturing a rotor according to claim 9, wherein the rotor is an inner rotor, which is located inward of the stator.

11. The method for manufacturing a rotor according to claim 9, wherein the rotor is an outer rotor, which is located outward of the stator.
